(19) United States
(12) Patent Application Publication
(10) Pub. No.: US 2025/0190928 A1
(43) Pub. Date: Jun. 12, 2025

(54) SYSTEM AND METHOD FOR DELIVERING PACKAGES

(71) Applicant: Shirley Moore, Garner, NC (US)

(72) Inventor: Shirley Moore, Garner, NC (US)

(21) Appl. No.: 18/978,041

(22) Filed: Dec. 12, 2024

Related U.S. Application Data
(60) Provisional application No. 63/609,052, filed on Dec. 12, 2023.

(51) Int. Cl. G06Q 10/0833; G06K 7/14; G08B 7/06; H04W 4/029

(52) U.S. Cl. CPC G06Q 10/0833; G06K 7/1417; G08B 7/06; H04W 4/029

(57) ABSTRACT

The present invention is a package scanning delivery solution system and associated mobile application. The application is integrated into a scanner software in a reader device. The application is adapted to detect the current location of a driver when the barcode of a package is scanned by the driver/deliverer and to compare with the intended delivery address of the package. The application generates an alert when there is a mismatch between the current location and the intended delivery address to prohibit a wrong delivery of the package. In some embodiments, the application provides directions to the intended delivery address along with an ETA. The application enables drivers to reach the correct delivery address safely and easily and saves time and effort.

### CROSS-REFERENCE TO RELATED APPLICATION

The present application claims priority to, and the benefit of, U.S. Provisional Application No. 63/609,052, which was filed on Dec. 12, 2023 and is incorporated herein by reference in its entirety.

### FIELD OF THE INVENTION

The present invention generally relates to the field of package delivery solutions. More specifically, the present invention relates to a package scanning delivery mobile application. The package scanning mobile application is integrated into a scanner software on an electronic computing device, the package scanning mobile application is adapted to use a location module integrated in the electronic computing device to identify a location of a driver, detect an intended delivery address of a package when a barcode or RFID tag of the package is scanned, and provide a visual and/or audible alert when the location of the driver/deliverer and the intended delivery address of the package do not match. Accordingly, the present disclosure makes specific reference thereto. Nonetheless, it is to be appreciated that aspects of the present invention are also equally applicable to other like applications, devices and methods of manufacture.

### BACKGROUND

By way of background, delivery partners transport goods from one location to another and are responsible for the careful handling of packages to prevent damage. Commonly, delivery partners use scanner software to scan the barcodes on packages. The scanner software provides information about the package, including the intended delivery location of the package. Often, delivery partners are not aware of locations and rely on GPS and other navigation tools to find delivery addresses. However, such tools may not always be up to date. The lack of familiarity with delivery areas can contribute to errors.

When a delivery driver scans a package and proceeds with delivery, there is a potential risk of leaving the package at the wrong address. This can happen due to various reasons such as misreading an address, navigation errors, or human error. Incorrect deliveries cost time, money, and cause frustration. A customer may not receive their package on time, or at all, leading to dissatisfaction and the need for redelivery. Carriers have to spend additional costs in retrieving and redelivering the package, and potentially compensating the customer. Commonly, the delivery partner is not notified of the wrong delivery address by conventional scanner software and other similar applications. Individuals desire an improved method for real-time address verification during delivery which eliminates incorrect deliveries of goods by delivery partners.

Therefore, there exists a long felt need in the art for a method to eliminate incorrect package delivery by delivery partners. There is also a long felt need in the art for a novel mobile application that can alert a delivery partner about an incorrect delivery address. Additionally, there is a long felt need in the art for a method that directs a delivery partner from the incorrect delivery address to the correct delivery address. There is also a long felt need in the art for an application that can be integrated into scanner software used by shipping carriers for providing an accurate package delivery location. Further, there is a long felt need in the art for an application that generates an automatic alert for the delivery partner when there is a discrepancy between the partner's location and correct delivery address. Finally, there is a long felt need in the art for a mobile application that provides real-time address verification during delivery and eliminates delivery of packages to a wrong address.

The subject matter disclosed and claimed herein, in one embodiment thereof, comprises a package scanning delivery solution system. The system comprises an electronic computing device in the form of a barcode reader or a smartphone, a package scanning mobile application integrated into a scanner software on the electronic computing device, wherein the package scanning mobile application is adapted to use a location module integrated in the electronic computing device to identify current location of a driver, detect an intended delivery address of a package when a barcode or RFID tag of the package is scanned, and provide a visual and/or audible alert when the location of the driver/deliverer and the intended delivery address of the package do not match. The application also provides a map displaying the current location and the intended delivery address along with an estimated time of arrival (ETA) from the current location to the intended delivery address.

In this manner, the package scanning solution system and application of the present invention accomplish all of the forgoing objectives and provide an application that works in conjunction with the scanner software and confirms the driver/deliverer's current location. The application also retrieves the intended delivery address of the package from the associated barcode or RFID tag. The application detects discrepancies between the location of the driver/deliverer and the intended delivery location of the package. The application sends an automatic alert to the delivery partner/driver when the driver/deliverer's location does not match the package's intended delivery address.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a package scanning delivery solution system. The system comprises an electronic computing device, a package scanning mobile application is integrated into a scanner software on the electronic computing device, wherein the package scanning mobile application is adapted to use a location module integrated in the electronic computing device to identify a location of a driver, detect an intended delivery address of a package when a barcode or RFID tag of the package is scanned, and provide a visual and/or audible alert when the location of the driver/deliverer and the intended delivery address of the package do not match.

In another aspect, a method for facilitating package delivery using a package scanning mobile application is disclosed. The method comprises detecting, by the scanning mobile application on an electronic computing device, a current location of a driver via a location module, scanning a barcode or RFID tag of a package to detect an intended delivery address of the package, comparing the current location of the driver/deliverer with the intended delivery address, and generating a notification and displaying a digital map with directions from the current location to the intended delivery address when a discrepancy between the current location of the driver/deliverer and the intended delivery address is detected.

In another embodiment, a method for updating a delivery status of a package is described. The method includes the steps of scanning a barcode of a package using scanner software on an electronic computing device, determining a current location of a driver using a location module integrated into the electronic computing device, retrieving a prestored intended delivery address of the package from a package scanning mobile application, comparing the current location with the intended delivery address of the package, providing a direction to the current delivery address, and updating the delivery status and providing an option to mark the package as delivered or initiate a query if a discrepancy exists between the current and intended delivery addresses.

In another aspect, a non-transitory computer-readable medium having instructions stored thereon which, when executed by a processor of an electronic computing device, cause the device to operate a package scanning mobile application integrated with scanner software, detect a current location of a driver using a location module, scan a barcode or RFID tag to determine an intended delivery address of a package, generate a visual and/or audible alert if the location of the driver/deliverer differs from the intended delivery address, and display a map with directions from the current location of the driver/deliverer to the intended delivery address.

In yet another embodiment, a non-transitory computer-readable medium comprising instructions that, when executed by a computing device, perform a method for updating package delivery status, the method comprises scanning a package identifier to retrieve an intended delivery address, detecting a current location of a driver via a location module, comparing the current location with the intended delivery address, displaying a notification on a discrepancy between the current and intended delivery addresses, and providing options on a user interface to mark the package as delivered or to address a delivery discrepancy.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of the package scanning delivery solution of the present invention in accordance with the disclosed architecture;

FIG. 2 illustrates an exemplary interface displayed by the package scanning mobile application upon scanning of a barcode of a package in accordance with one embodiment of the present invention;

FIG. 3 illustrates a directions interface displayed by the package scanning mobile application of the present invention in accordance with one embodiment of the present invention;

FIG. 4 illustrates another user interface displayed by the mobile application in accordance with disclosed architecture;

FIG. 5 illustrates an exemplary delivery address update interface displayed by the mobile application in accordance with the disclosed architecture; and

FIG. 6 illustrates a flow chart depicting a process of alerting a driver/deliverer of package delivery correct address in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a method to eliminate incorrect package delivery by delivery partners. There is also a long felt need in the art for a novel mobile application that can alert a delivery partner about an incorrect delivery address. Additionally, there is a long felt need in the art for a method that directs a delivery partner from the incorrect delivery address to the correct delivery address. There is also a long felt need in the art for an application that can be integrated into scanner software used by shipping carriers for providing an accurate package delivery location. Further, there is a long felt need in the art for an application that generates an automatic alert for the delivery partner when there is a discrepancy between the partner's location and correct delivery address. Finally, there is a long felt need in the art for a mobile application that provides real-time address verification during delivery and eliminates delivery of packages to a wrong address.

The present invention, in one exemplary embodiment, is a non-transitory computer-readable medium having instructions stored thereon which, when executed by a processor of an electronic computing device, cause the device to operate a package scanning mobile application integrated with scanner software, detect a current location of a driver using a location module, scan a barcode or RFID tag to determine an intended delivery address of a package, generate a visual and/or audible alert if the location of the driver/deliverer differs from the intended delivery address, and display a map with directions from the current location of the driver/deliverer to the intended delivery address.

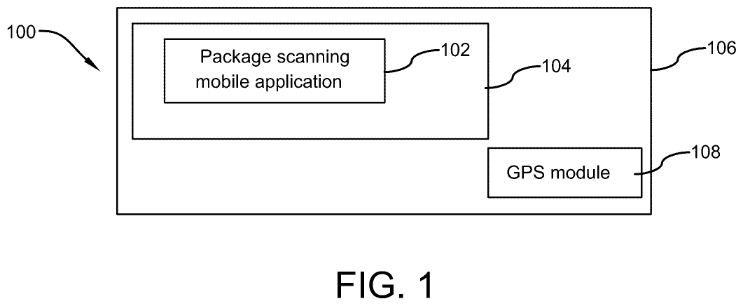

Referring initially to the drawings, FIG. 1 illustrates a diagrammatic view of the package scanning delivery solution of the present invention in accordance with the disclosed architecture. The package scanning delivery solution 100 includes a package scanning mobile application 102 integrated into a scanner software 104 of a shipping carrier. The scanner software 104 can be included in an electronic computing device 106 which can be a customized reader device or any handheld electronic device. The package scanning mobile application 102 is adapted to use the GPS or any other location module 108 integrated in the device 106 for identifying location of a driver or delivery partner.

The package scanning mobile application 102 is also adapted to detect the intended delivery address of a package. The intended delivery address can be prestored in the application 102 or can also be detected by the application 102 when barcode or RFID tag of a package is scanned by the scanner software 104.

The package scanning application 102 is a customized application for compatibility with the scanner software of different carrier companies and provides a visual and/or audible alert when location of the driver/deliverer and intended delivery address of the package are different. The application 102 is also adapted to display a digital map showing directions from the location of the driver/deliverer to the intended destination (i.e., delivery address) of the package. The package scanning solution system 100 helps drivers in reaching correct delivery location of a package in order to mitigate errors in package delivery.

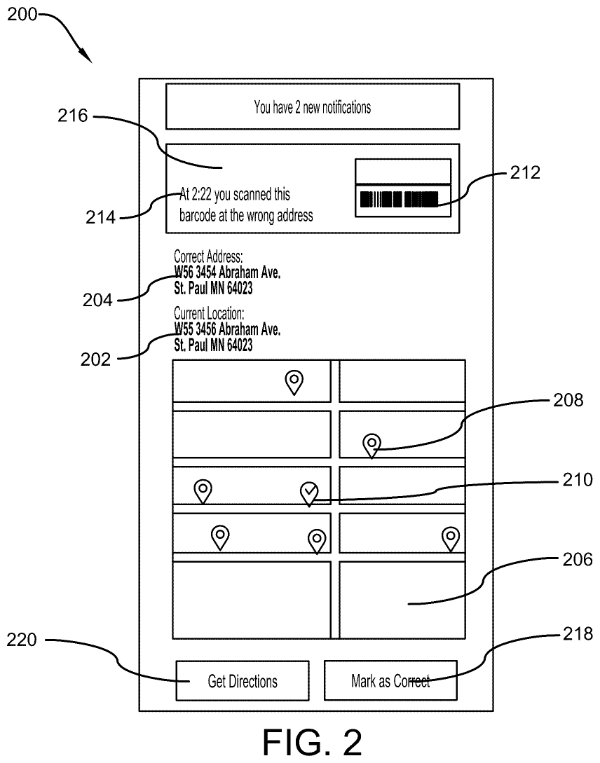

FIG. 2 illustrates an exemplary interface displayed by the package scanning mobile application 102 upon scanning of a barcode of a package in accordance with one embodiment of the present invention. As illustrated, the interface 200 displays current location 202 of the driver/deliverer wherein the location can be detected using the GPS module of the reader device in which the application 102 is installed. Preferably, the application 102 detects the current location when a barcode is scanned by a driver using the reader device.

The application 102 is prestored with the correct delivery address of the package whose barcode is scanned by the driver/deliverer. In some embodiments, the application 102 may be in communication with a server (not shown) for receiving correct delivery address of the package. The correct delivery address 204 is displayed on the interface 200 for easy accessibility by the driver/deliverer. The interface 200 also displays a digital map 206 which includes a sign or indicia 208 representing current location and another sign or indicia 210 representing the correct delivery location of the package.

The interface 200 displays the barcode 212 scanned by the driver/deliverer along with a timestamp 214 on which the barcode 212 is scanned. If the current address and the correct delivery address are different, then a text message 216 indicating wrong address delivery is displayed on the interface 200. It will be apparent to a person skilled in the art that the text message 216 can be supplemented by an audio message, a vibration or any other type of alert.

To reduce false positives, a “Mark as correct” option 218 is provided by the interface 200 enabling a driver/deliverer to mark the current location as the correct delivery address. This functionality enables to override the incorrect delivery address detected by the system or the incorrect current address detected by the GPS or the location module.

In many cases, if a driver is not aware of the directions such as in a new area, then the “Get Directions” option 220 can be used and the application 102 can provide the directions from the current address to the correct delivery address of the package.

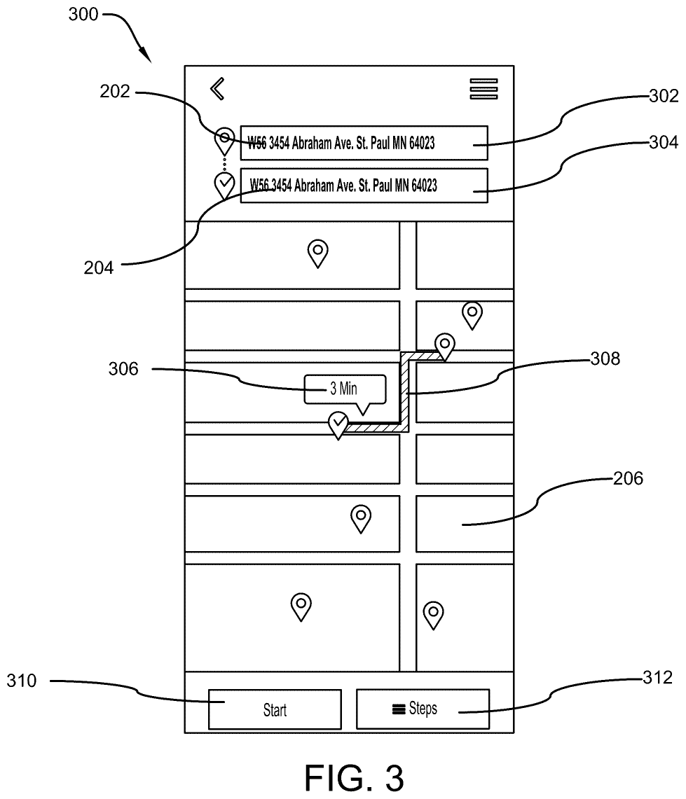

FIG. 3 illustrates a directions interface displayed by the package scanning mobile application of the present invention in accordance with one embodiment of the present invention. The directions interface 300 is displayed when a driver selects the “Get Directions” option 220 on the interface 200. The directions interface 300 displays the current address/location 202 as the starting address 302 and the correct delivery address 204 as the destination (i.e., delivery address) 304. The digital map 206 displays an estimated time 306 along with the best path 308 between the current location indica 208 and the correct delivery address indicia 210.

The interface 300 can display real time movement/location of the driver/deliverer along the path on the map 206 and the navigation can be started using the “Start” button 310. The interface 300 displays the number of steps when the “Steps” button 312 is selected by a driver.

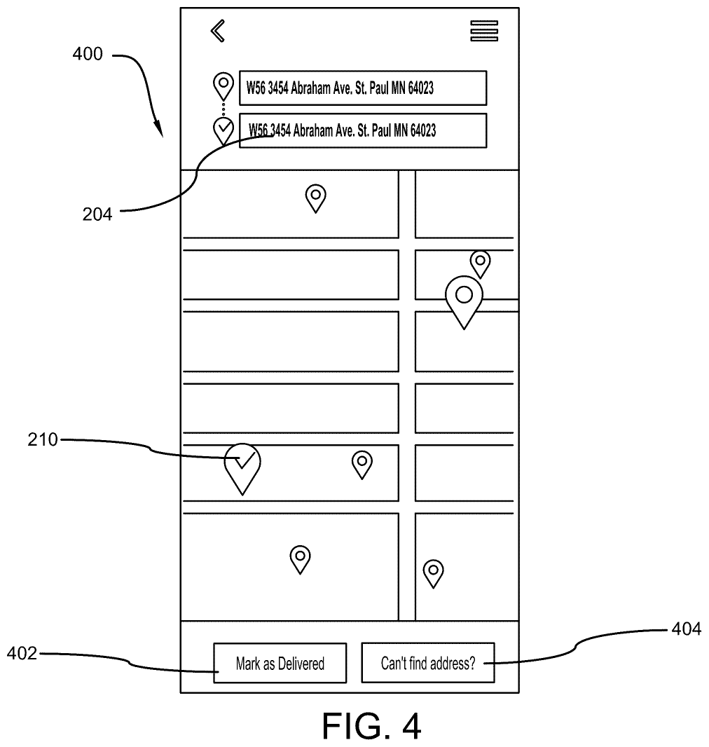

FIG. 4 illustrates another user interface displayed by the mobile application in accordance with disclosed architecture. If the driver/deliverer reaches the correct package delivery location 204, then the interface 400 provides two options for the driver/deliverer to select. The first option “Marked as delivered” 402 enables the driver/deliverer to mark status of the package as delivered at the correct delivery address. When the option 402 is selected, the delivery status is updated along with the correct delivery address. If the driver/deliverer is unable to find the address, then the option “Can't find address?” 404 is selected and an automatic call to customer service or the recipient of the package can be made. Alternatively, the status of the package can be updated as non-delivered and the driver/deliverer may return the package to the shipping carrier company.

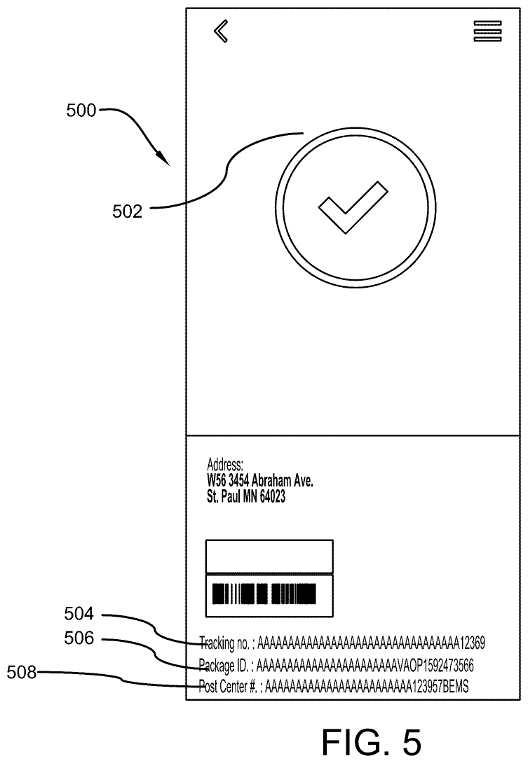

FIG. 5 illustrates an exemplary delivery address update interface displayed by the mobile application in accordance with the disclosed architecture. If the “Marked as delivered” option 402 is selected by a driver, then the interface 500 is displayed and a notice 502 indicating update of delivery address is displayed. The correct delivery address is also displayed on the interface 500 along with the additional information such as tracking id 504, package id 506, and post center id 508. It will be apparent to a person skilled in the art that application 102 enables a driver to reach a correct delivery address easily to prohibit delivery at wrong address.

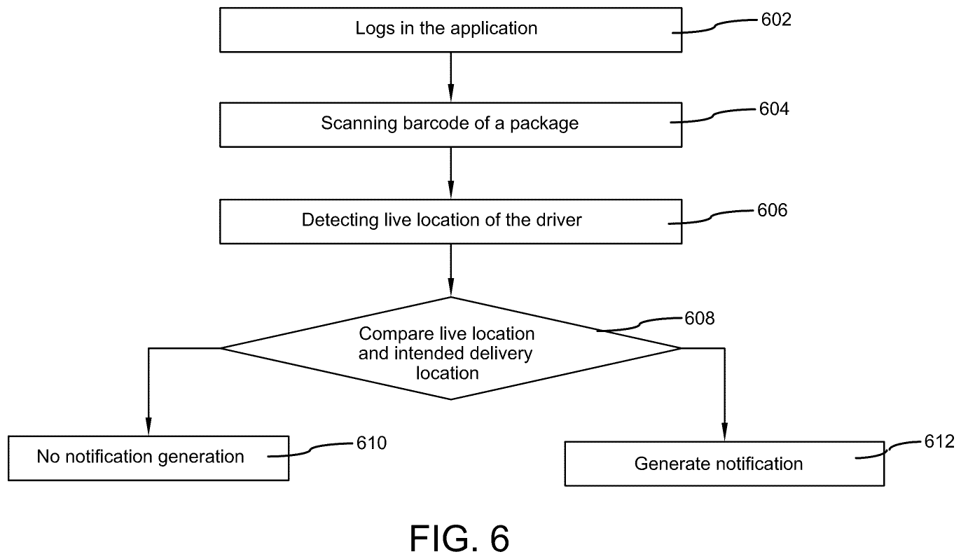

FIG. 6 illustrates a flow chart depicting a process of alerting a driver/deliverer of package delivery correct address in accordance with one embodiment of the present invention. Initially, a driver logs in the mobile application 102 (Step 602). The application 102 can also be automatically logged into when the driver/deliverer is authenticated by the software scanner. Then a barcode is scanned by the driver/deliverer using the scanner software for reading the encoded information of the barcode (Step 604). When the barcode is scanned, the current location of the driver/deliverer is detected by the application 102 (Step 606). Thereafter, the application 102 compares the current location of the driver/deliverer and the intended delivery address of the package (Step 608). The intended delivery address can be prestored in the application or can also be retrieved from a server or any other third-party sources. If the current location and the intended delivery address are the same, then no notification is generated by the application 102 and the package is marked as delivered (Step 610). When there is a discrepancy between the current location and the intended delivery address, a visual and audible notification is generated by the application 102 along with different options for directing the driver/deliverer to correct delivery address (Step 612).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

Furthermore, one or more examples described herein may be implemented through the use of instructions that are executable by one or more processors. These instructions may be carried out on a computer-readable medium. Examples of computer-readable mediums include permanent memory-storage devices, such as hard drives on personal computers or servers. Other examples of computer-storage mediums include portable storage units, such as CD or DVD units, flash memory drives (such as carried on smartphones, multifunctional devices or tablets), and magnetic memory devices. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer-usable carrier medium capable of carrying such a program.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “package scanning delivery application”, “package scanning application”, “mobile application”, and “application” are interchangeable and refer to the package scanning delivery application 102 of the present invention. Similarly, as used herein, “package scanning delivery solution” and “package scanning solution system” are interchangeable and refer to the package scanning correct delivery solution 100 of the present invention.

Notwithstanding the forgoing, the package scanning correct delivery solution 100 and the package scanning delivery application 102 of the present invention can include any additional components to enhance the functionality and efficiency of the package scanning correct delivery solution 100 and the package scanning delivery application 102. One of ordinary skill in the art will appreciate that the configuration and components of the package scanning correct delivery solution 100 and the package scanning delivery application 102, as shown in the FIGS., are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A package scanning delivery system comprising:
a handheld electronic computing device having a package scanning mobile application including a location module for identifying a location of a deliverer and a scanner having a scanner software;
wherein said package scanning mobile application detects an intended delivery address of a package;
wherein said intended delivery address of the package includes a tag selected from the group consisting of a barcode tag and an RFID tag;
wherein said detecting of said intended delivery address includes scanning said tag by said scanner;
wherein said package scanning mobile application compares said intended delivery address of the package to said location of the deliverer; and
further wherein said package scanning mobile application provides an alert when said intended delivery address of the package is different from said location of the deliverer.

2. The package scanning delivery system of claim 1, wherein said alert is selected from the group consisting of one or more of a visual alert, an audible alert, a vibration alert, and a text message alert.

3. The package scanning delivery system of claim 2, wherein said package scanning mobile application having a digital map display for showing directions from said location of the deliverer to said intended delivery address of the package.

4. The package scanning delivery system of claim 3, wherein said location module is a GPS location tracker.

5. The package scanning delivery system of claim 4, wherein said intended delivery address of the package is prestored in said package scanning mobile application.

6. The package scanning delivery system of claim 5, wherein said digital map display having a first indicia showing said location of the deliverer and a second indicia showing said intended delivery address of the package.

7. The package scanning delivery system of claim 6, wherein said scanning of said tag includes a timestamp.

8. The package scanning delivery system of claim 1, wherein said alert is a first text message and a second message selected from the group consisting of an audio message and a vibration alert.

9. The package scanning delivery system of claim 8, wherein said text message indicates a wrong address delivery.

10. A package scanning delivery system comprising:
a handheld electronic computing device having a package scanning mobile application including a location module for identifying a location of a deliverer, a scanner having a scanner software, and a directions interface;
wherein said package scanning mobile application detects an intended delivery address of a package;
wherein said intended delivery address of the package includes a tag selected from the group consisting of a barcode tag and an RFID tag;
wherein said detecting of said intended delivery address includes scanning said tag by said scanner;
wherein said package scanning mobile application compares said intended delivery address of the package to said location of the deliverer;
wherein said package scanning mobile application provides an alert when said intended delivery address of the package is different from said location of the deliverer;
wherein said directions interface is displayed by said package scanning mobile application; and
further wherein said directions interface displays said location of the deliverer as a starting location and displays said intended delivery address as a destination location.

11. The package scanning delivery system of claim 10, wherein said directions interface displays real time movements of said location of the deliverer.

12. The package scanning delivery system of claim 11, wherein said alert is selected from the group consisting of one or more of a visual alert, an audible alert, a vibration alert, and a text message alert.

13. The package scanning delivery system of claim 12, wherein said package scanning mobile application having a digital map display for showing directions from said location of the deliverer to said intended delivery address of the package.

14. The package scanning delivery system of claim 13, wherein said location module is a GPS location tracker.

15. The package scanning delivery system of claim 14, wherein said intended delivery address of the package is prestored in said package scanning mobile application.

16. The package scanning delivery system of claim 15, wherein said digital map display having a first indicia showing said location of the deliverer and a second indicia showing said intended delivery address of the package.

17. The package scanning delivery system of claim 16, wherein said scanning of said tag includes a timestamp.

18. The package scanning delivery system of claim 10, wherein said alert is a first text message and a second message selected from the group consisting of an audio message and a vibration alert.

19. The package scanning delivery system of claim 18, wherein said text message indicates a wrong address delivery.

20. A method of delivering a package, the method comprising the steps of:
providing a handheld electronic computing device having a package scanning mobile application including a location module for identifying a location of a deliverer, a scanner having a scanner software, and a directions interface, wherein said directions interface is displayed by said package scanning mobile application;
detecting an intended delivery address of a package with said package scanning mobile application, wherein said intended delivery address of the package includes a tag selected from the group consisting of a barcode tag and an RFID tag;
scanning said tag by said scanner for said detecting of said intended delivery address;
comparing said intended delivery address of the package to said location of the deliverer;
alerting the deliverer when said intended delivery address of the package is different from said location of the deliverer;
displaying said location of the deliverer as a starting location; and
displaying said intended delivery address as a destination location.
